(19) United States
(12) Patent Application Publication
(10) Pub. No.: US 2026/0043452 A1
(43) Pub. Date: Feb. 12, 2026

(54) SHOCK ABSORBER

(71) Applicant: KYB MOTORCYCLE SUSPENSION CO., LTD., Gifu (JP)

(72) Inventors: Nobuhiro NOGUCHI, Gifu (JP); Yuichi AMIKI, Gifu (JP); Takeshi MORI, Gifu (JP)

(73) Assignee: KYB MOTORCYCLE SUSPENSION CO., LTD., Gifu (JP)

(21) Appl. No.: 19/101,906

(22) PCT Filed: Nov. 27, 2023
(86) PCT No.: PCT/JP2023/042284

§ 371 Date: Feb. 7, 2025

(30) Foreign Application Priority Data
Dec. 26, 2022 (JP) 2022-207722

(51) Int. Cl. F16F 9/348; B62K 25/08

(52) U.S. Cl. CPC F16F 9/348; B62K 25/08

(57) ABSTRACT

A shock absorber includes a shock absorber main body that is extendable and contractible, a valve disc that partitions two operation chambers in the shock absorber main body, a check valve that is stacked on one end side of the valve disc and opens and closes first ports, and a valve stopper that is disposed on a counter-valve disc side of the check valve. The first ports and second ports are alternately arranged in a circumferential direction of the valve disc. The check valve includes a plurality of valve portions that are continuous with an outer periphery of an inner ring facing an inner peripheral side of the valve disc and independently open and close only the first ports. The valve stopper has claws that extend from an outer periphery of an annular plate and are inserted into the second ports to regulate circumferential rotation of the check valve.

### TECHNICAL FIELD

The present invention relates to a shock absorber.

### BACKGROUND ART

Conventionally, as disclosed in JP 2022-39150 A, for example, a shock absorber includes: a shock absorber main body that has a cylinder and a rod movably inserted into the cylinder, the shock absorber main body being extendable and contractible; an annular valve disc that partitions a compression side chamber and a reservoir as two operation chambers in the shock absorber main body, the valve disc including a plurality of first ports and a plurality of second ports that allow communication between the two operation chambers; an annular check valve that is stacked on one end side of the valve disc to open and close the first ports; and an annular leaf valve that is stacked on the other end side of the valve disc to open and close the second ports, and is incorporated in a front fork that suspends front wheels of a straddle vehicle such as a two-wheeled vehicle.

In the shock absorber of Patent Literature 1, the first ports and the second ports are alternately arranged on the same circumference of the valve disc, the valve disc includes a circular annular inner peripheral portion provided on an inner peripheral side of the first ports and the second ports, and a valve seat including surrounding portions connected to an outer periphery of the inner peripheral portion and individually surrounding the first ports, and the check valve includes an inner ring facing the inner peripheral portion of the valve disc, and a plurality of valve portions radially provided on an outer periphery of the inner ring at intervals in a circumferential direction and separated from and seated on the surrounding portions to independently open and close the first ports.

In the shock absorber configured as described above, since the valve portions of the check valve do not reduce the flow path area of inlets of the second ports, a damping force of the shock absorber does not become excessive even when an extension/contraction speed of the shock absorber becomes high and a flow rate of a liquid passing through the second ports increases.

### CITATION LIST

### Patent Literature

Patent Literature 1: JP 2022-39150 A

### SUMMARY OF INVENTION

### Technical Problem

In the shock absorber disclosed in JP 2022-39150 A, the valve disc includes a plurality of positioning portions protruding and rising in an axial direction on the outer peripheral side of the inner peripheral portion between the surrounding portions. When the check valve is stacked on one end of the valve disc, the positioning portions are disposed between the valve portions adjacent to each other in the circumferential direction and come into sliding contact with side surfaces of the valve portions, so that the check valve can be positioned in the circumferential direction at a position where the valve portions directly face the surrounding portions. That is, in the shock absorber of Patent Literature 1, even when the check valve is formed in a petal shape including an inner ring and a plurality of valve portions radially extending from the outer periphery of the inner ring, the check valve can be positioned at an appropriate position with respect to the valve disc when the check valve is assembled to the valve disc.

However, when a check valve made of an annular plate having a circular annular shape is stacked on the valve disc having such positioning portions, the check valve cannot close the second ports. This is because, in the circular annular check valve, the positioning portions interfere and cannot be seated on the valve seat, and the second ports cannot be closed.

That is, the valve disc having the positioning portions is a dedicated product used only for a shock absorber having a petal-shaped check valve, and cannot be used for a circular annular check valve, and thus, versatility is poor. Therefore, in the conventional shock absorber, it is necessary to manufacture a dedicated valve disc in order to position the petal-shaped check valve in the circumferential direction, which causes an increase in cost.

Therefore, an object of the present invention is to provide a shock absorber capable of positioning a check valve in a circumferential direction with respect to a valve disc without providing a positioning portion in the valve disc.

### Solution to Problem

In order to solve the above-described problem, a shock absorber of the present invention includes: a shock absorber main body that is extendable and contractible; a valve disc that partitions two operation chambers in the shock absorber main body, the valve disc including a plurality of first ports and a plurality of second ports that allow communication between the two operation chambers; an annular check valve that is stacked on one end side of the valve disc and opens and closes the first ports; an annular leaf valve that is stacked on the other end side of the valve disc and opens and closes the second ports; and a valve stopper that is disposed on a counter-valve disc side of the check valve, in which the first ports and the second ports are alternately arranged in a circumferential direction of the valve disc, the check valve includes an inner ring facing an inner peripheral side of the first ports and the second ports of the valve disc, and a plurality of valve portions that are continuous with an outer periphery of the inner ring and independently open and close only the first ports, and the valve stopper includes an annular plate facing the inner ring of the check valve in an axial direction, and claws that extend from an outer periphery of the plate and are inserted into the second ports to regulate circumferential rotation of the check valve. According to this configuration, the circumferential rotation of the check valve is regulated by the claws of the valve stopper, and the check valve can be positioned at a position where the valve portions face the first ports.

### BRIEF DESCRIPTION OF DRAWINGS

FIG. 1 is a front side cross-sectional view of a front fork to which a shock absorber according to the present embodiment is applied.

FIG. 2 is an enlarged front side cross-sectional view illustrating a valve of the shock absorber according to the present embodiment.

FIG. 3 is a perspective view of a valve disc of the shock absorber according to the present embodiment as viewed from one end side.

FIG. 4 is a perspective view of the valve disc of the shock absorber according to the present embodiment as viewed from the other end side.

FIG. 5 is a bottom view of a valve of the shock absorber according to the present embodiment.

FIG. 6 is a perspective view of a valve stopper of the shock absorber according to the present embodiment.

FIG. 7 is a bottom view of a valve disc of a shock absorber according to a modification of the present embodiment.

FIG. 8 is a partially enlarged cross-sectional view of a valve of the shock absorber according to the modification of the present embodiment.

### DESCRIPTION OF EMBODIMENTS

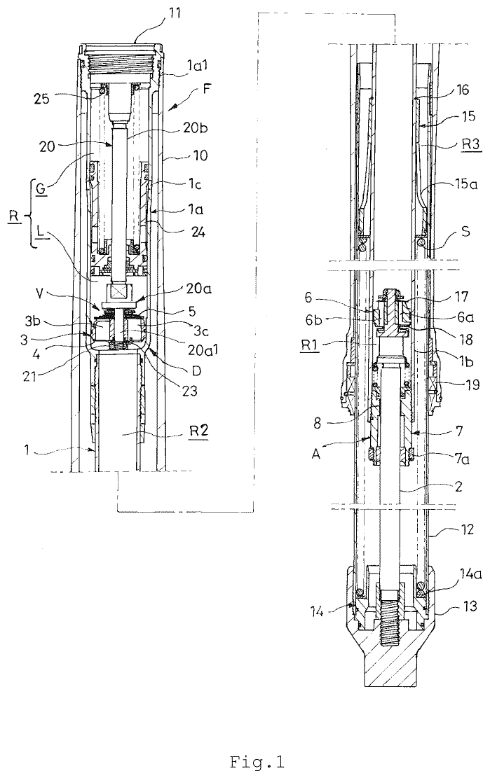

Hereinafter, the present invention will be described based on an embodiment illustrated in the drawings. As illustrated in FIG. 1, a shock absorber D according to one embodiment includes: a shock absorber main body A which includes a cylinder 1, a rod 2 that is movably inserted into the cylinder 1, and a piston 6 that is connected to the rod 2, is movably inserted into the cylinder 1, and partitions an inside of the cylinder 1 into an extension side chamber R1 and a compression side chamber R2, the shock absorber main body being extendable and contractible; a valve disc 3 that is inserted into the cylinder 1 and partitions the inside of the cylinder 1 into the compression side chamber R2 and a reservoir R; and a damping valve V that includes a check valve 4 and a leaf valve 5 stacked on the valve disc 3. The shock absorber D is incorporated in a front fork F that suspends front wheels of a straddle vehicle such as a two-wheeled vehicle (not illustrated).

As illustrated in FIG. 1, the front fork F includes: a tubular vehicle body side tube 10 of which an upper end in FIG. 1 is closed by a cap 11 and which can be attached to a vehicle body side of the straddle vehicle (not illustrated) ; an axle side tube 12 which is slidably inserted into the vehicle body side tube 10 and of which a lower end in FIG. 1 is closed by a bottom cap 13 and which can be attached to a front wheel side of the straddle vehicle (not illustrated); the shock absorber D which is accommodated in a closed space formed by the vehicle body side tube 10 and the axle side tube 12 and is interposed between the vehicle body side tube 10 and the axle side tube 12; and a suspension spring S which is interposed between the cylinder 1 and the bottom cap 13 and biases the vehicle body side tube 10 and the axle side tube 12 in a direction separating them from each other. The front fork F is interposed between the front wheel and the vehicle body of the straddle vehicle (not illustrated), elastically supports the vehicle body by a resilient force exerted by the suspension spring S, and attenuates vibration of the vehicle body by a damping force generated by the shock absorber D.

In the following description, the upper and lower sides of the shock absorber D and the front fork F in a state where the shock absorber D and the front fork F are attached to the straddle vehicle are referred to as “upper” and “lower” of the shock absorber D and the front fork F, respectively, unless otherwise specified. Further, the straddle vehicle equipped with the front fork F incorporating the shock absorber D refers to a general vehicle in which an occupant rides in a straddling posture, and includes a motorcycle (including a scooter), a tricycle, and the like. The shock absorber D according to the present invention may be used for other than the front fork.

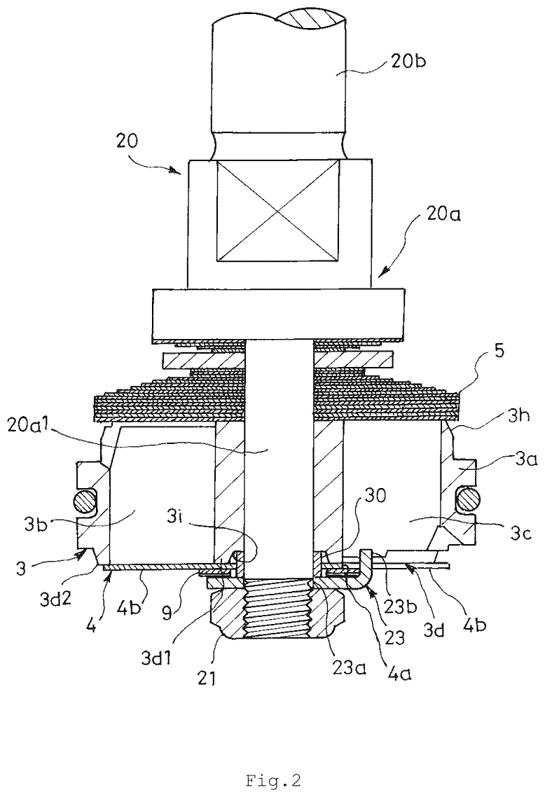

Hereinafter, the shock absorber D of one embodiment and each portion of the front fork F to which the shock absorber D is applied will be described in detail. As illustrated in FIGS. 1 and 2, the front fork F is configured as a telescopic front fork including the vehicle body side tube 10 and the axle side tube 12 slidably inserted into the vehicle body side tube 10. When vibration acts on the front fork F, the axle side tube 12 moves into or from the vehicle body side tube 10 to extend and contract. Note that in the present embodiment, the front fork F is of an inverted type in which the axle side tube 12 is inserted into the vehicle body side tube 10, but may be of an upright type in which the vehicle body side tube 10 is inserted into the axle side tube 12.

Subsequently, the annular cap 11 is mounted to the upper end of the vehicle body side tube 10 in FIG. 2 via the cylinder 1 of the shock absorber D. The lower end of the axle side tube 12, which is the lower end of the front fork F, in FIG. 1 is closed by the bottom cap 13. Further, a space between the vehicle body side tube 10 and the axle side tube 12 is sealed by an annular seal member 19 mounted to the lower end of the vehicle body side tube 10 and coming into sliding contact with the outer periphery of the axle side tube 12, whereby the inside of the front fork F is sealed.

In this manner, the inside of the front fork F becomes a sealed space, and the shock absorber D is accommodated inside the front fork F. The inside of the front fork F and the outside of the shock absorber D is used as a liquid storage chamber R3, and is filled with a gas and a liquid. Although the liquid is hydraulic oil in the present embodiment, a liquid other than hydraulic oil can be used.

In the present embodiment, the shock absorber D includes: the shock absorber main body A that includes the cylinder 1 that is accommodated in the axle side tube 12 and is filled with hydraulic oil, the rod 2 that is movably inserted into the cylinder 1, and the piston 6 that is connected to the rod 2, is movably inserted into the cylinder 1, and partitions the inside of the cylinder 1 into the extension side chamber R1 and the compression side chamber R2; the valve disc 3 that is inserted into the cylinder 1 and partitions the compression side chamber R2 and the reservoir R in the cylinder 1; and the check valve 4 and the leaf valve 5 stacked on the valve disc 3.

The cylinder 1 includes a reservoir cylinder 1a having a screw portion 1a1 on the outer periphery of the upper end and a tubular cylinder body 1b connected to the lower end of the reservoir cylinder 1a, and is connected to the vehicle body side tube 10 by screw connection of the screw portion 1a1 to the inner periphery of the upper end of the vehicle body side tube 10. The cap 11 is mounted to an opening edge of the upper end of the reservoir cylinder 1a, and is closed by the cap 11. A tubular rod guide 7 through which the rod 2 is inserted is mounted to the inner periphery of the lower end of the cylinder body 1b, and the lower end of the cylinder 1 is closed.

The valve disc 3 is inserted into the reservoir cylinder 1a in the cylinder 1. The valve disc 3 partitions the inside of the cylinder 1 into the compression side chamber R2 and the reservoir R. Further, the piston 6 is inserted into the cylinder body 1b in the cylinder 1 so as to be movable in an upward/downward direction, which is an axial direction. The piston 6 partitions the inside of the cylinder 1 into the extension side chamber R1 and the compression side chamber R2.

The lower end of the rod 2 is connected to the bottom cap 13 that closes the lower end of the vehicle body side tube 10, and the upper end side thereof is inserted into the cylinder body 1b. The bottom cap 13 has a bottomed tubular shape and is connected to the outer periphery of the axle side tube 12 by screw connection. A tubular oil lock case 14 forming an oil lock chamber on the outer periphery of the rod 2 is placed on the bottom portion of the bottom cap 13, and the oil lock case 14 is sandwiched between the bottom cap 13 and the axle side tube 12 and is immovably fixed to the rod 2.

A tubular spring seat 15 that supports the upper end of the suspension spring S is mounted to the outer periphery of the cylinder body 1b. The spring seat 15 has a tubular shape in which the upper end fitted to the outer periphery of the cylinder body 1b has a minimum diameter and the diameter increases as it goes downward, and has a hole 15a in the side portion. The suspension spring S is interposed between the spring seat 15 and a spring seat 14a in the oil lock case 14. Since the upward movement of the spring seat 15 with respect to the cylinder body 1b is regulated by a C-ring 16 mounted to the outer periphery of the cylinder body 1b, the force received from the suspension spring S via the cylinder 1 is transmitted to the vehicle body side tube 10. Therefore, the suspension spring S exerts a resilient force that presses the vehicle body side tube 10 upward and presses the axle side tube 12 downward to separate them from each other.

An annular bush 8 coming into sliding contact with the outer periphery of the rod 2 is attached to the inner periphery of the upper end of the rod guide 7, and an annular oil lock piece 7a is mounted to the outer periphery of the lower end of the rod guide 7. When the vehicle body side tube 10 and the axle side tube 12 approach each other and the front fork F contracts to the vicinity of the maximum contraction, the oil lock piece 7a mounted to the outer periphery of the rod guide 7 enters the oil lock case 14. An appropriate gap is provided between the outer periphery of the oil lock piece 7a and the inner periphery of the oil lock case 14, and resistance is applied to the flow through which the hydraulic oil flows out from the inside of the oil lock case 14. Therefore, when the oil lock piece 7a enters the oil lock case 14, the pressure in the oil lock case 14 increases and further contraction of the front fork F is hindered, so that the impact at the time of maximum contraction of the front fork F is alleviated.

Returning to the above, the piston 6 is mounted to the outer periphery of the upper end of the rod 2 inserted into the cylinder 1. The piston 6 is slidably in contact with the inner periphery of the cylinder body 1b, is movable in the axial direction, which is the upward/downward direction with respect to the cylinder body 1b, and as described above, partitions the inside of the cylinder 1 into the extension side chamber R1 and the compression side chamber R2. The piston 6 includes an extension side port 68 and a compression side port 6b that allow communication between the extension side chamber R1 and the compression side chamber R2. On the compression side chamber R2 side of the piston 6, an extension side leaf valve 17 that opens and closes an outlet end of the extension side port 6a is stacked in a state fixed to the outer periphery of the rod 2, and on the extension side chamber R1 side of the piston 6, a check valve 18 that opens and closes an outlet end of the compression side port 6b is stacked in a state fixed to the outer periphery of the rod 2.

In the shock absorber D of the present embodiment, the extension side leaf valve 17 is a stacked leaf valve formed by stacking a plurality of annular plates and the inner periphery thereof is fixed to the outer periphery of the rod 2 and is allowed to deflect on the outer peripheral side. In addition, the extension side leaf valve 17 gives resistance to the flow of the hydraulic oil when the hydraulic oil moves from the extension side chamber RI to the compression side chamber R2 via the extension side port 68, and inhibits the hydraulic oil from moving from the compression side chamber R2 toward the extension side chamber R1.

In the shock absorber D of the present embodiment, the check valve 18 is formed of an annular plate, and the inner periphery thereof is fixed to the outer periphery of the rod 2 and is allowed to deflect on the outer peripheral side. In addition, the check valve 18 allows the flow of the hydraulic oil moving from the compression side chamber R2 to the extension side chamber RI via the compression side port 6b with substantially no resistance, and inhibits the hydraulic oil from moving from the extension side chamber R1 to the compression side chamber R2.

Next, the damping valve V will be described in detail. As illustrated in FIGS. 1 to 4, the damping valve V of the present embodiment includes: the valve disc 3 that is inserted into the cylinder 1, partitions the compression side chamber R2 and the reservoir R as two operation chambers in the cylinder 1, and the valve disc 3 including a plurality of first ports 3b and second ports 3c that allow communication between the compression side chamber R2 and the reservoir R; the annular check valve 4 that is stacked on the lower end side in the drawing, which is one end side of the valve disc 3, and opens and closes the first ports 3b; the annular leaf valve 5 that is stacked on the upper end side in the drawing, which is the other end side of the valve disc 3, and opens and closes the second ports 3c; and an annular valve stopper 23 that is disposed on the counter-valve disc side of the check valve 4.

Each portion of the damping valve V will be described in detail below. The valve disc 3 has an annular shape and is mounted to the outer periphery of the lower end of the guide rod 20 connected to the cap 11 in FIG. 1. In this manner, the valve disc 3 is positioned in the axial direction by the guide rod 20 and accommodated in the cylinder 1. The valve disc 3 is fitted to the inner periphery of the reservoir cylinder 1a and is immovably fixed to the cylinder 1 by the guide rod 20 to partition the inside of the cylinder 1 into the compression side chamber R2 and the reservoir R as described above.

As illustrated in FIGS. 2 to 4, the valve disc 3 includes an annular main body portion 3a, four fan-shaped first ports 3b and four fan-shaped second ports 3c alternately arranged on the same circumference of the main body portion 3a, and a valve seat 3d provided at one end of the main body portion 3a to surround the first ports 3b. The first ports 3b and the second ports 3c penetrate the main body portion 3a from one end, which is the lower end in FIG. 2 to the other end, which is the upper end in FIG. 2, and allow communication between the compression side chamber R2 and the reservoir R.

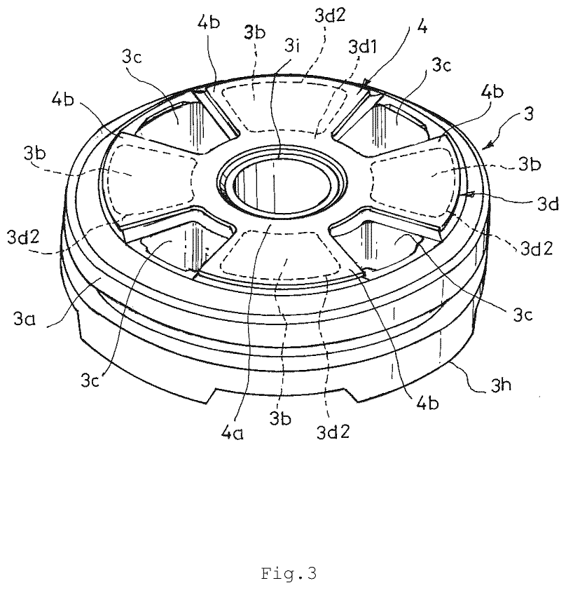

As illustrated in FIG. 3, the valve seat 3d includes a circular annular inner peripheral portion 3d1 provided on the inner peripheral side of the first ports 3b and the second ports 3c at one end, and four surrounding portions 3d2 that are continuous with the outer periphery of the inner peripheral portion 3d1 and individually surround each of the four first ports 3b, and is formed in a petal type, and is provided so as to protrude from one end of the main body portion 3a toward the compression side chamber R2 side, which is the lower side in FIG. 2. The second port 3c is opened between the surrounding portions 3d2 and 3d2 adjacent to each other in the circumferential direction on one end side of the valve disc 3.

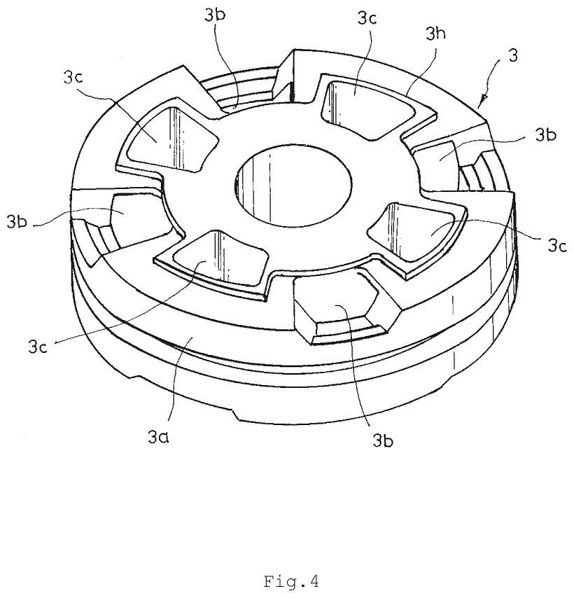

As illustrated in FIG. 4, a petal-type valve seat 3h surrounding only the second ports 3c while avoiding the first ports 3b is provided at the other end of the valve disc 3. The petal-type valve seat 3h is provided so as to protrude in the axial direction from the other end of the main body 3a toward the reservoir R side, which is the upper side in FIG. 2.

The check valve 4 is stacked on the valve seat 3d on one end side of the valve disc 3, that is, on the valve seat 3d provided at the end on the compression side chamber R2 side so as to be movable toward and away from the valve seat 3d in the axial direction. The check valve 4 includes an inner ring 4a facing the inner peripheral portion 3d1 of the valve seat 3d, and four fan-shaped valve portions 4b that are continuous with the outer periphery of the inner ring 4a, are radially provided at intervals in the circumferential direction, face the surrounding portions 3d2 respectively, and independently open and close only the first ports 3b.

An annular spring member 9 that biases the check valve 4 toward the valve disc 3 side is interposed between the check valve 4 and the valve stopper 23 to be described later.

As a result, the check valve 4 closes the first ports 3b when the valve portions 4b are seated on the surrounding portions 3d2, and when the pressure of the reservoir R acting on the front surface side which is the side of the first ports 3b becomes larger than the pressure of the compression side chamber R2 acting on the back surface side, the check valve 4 entirely separates the first ports 3b from the valve disc 3 against the biasing force of the spring member 9 to open the first ports 3b, thereby allowing the flow of the hydraulic oil from the reservoir R toward the compression side chamber R2. At this time, the biasing force of the spring member 9 is set to a force that hardly gives resistance to the flow of the hydraulic oil moving from the reservoir R to the compression side chamber R2 via the first ports 3b. In addition, when the pressure of the compression side chamber R2 is larger than the pressure of the reservoir R, the valve portions 4b of the check valve 4 are pressed against the surrounding portions 3d2 to close the first ports 3b, thereby inhibiting the flow of the hydraulic oil from the compression side chamber R2 toward the reservoir R.

As described above, the check valve 4 includes the inner ring 4a and the valve portions 4b that are continuous with the outer periphery of the inner ring 4a and radially extend at intervals in the circumferential direction, and the valve portions 4b are seated only on the surrounding portions 3d2 while avoiding the second ports 3c, so that the opening area of the inlet ends of the second ports 3c is not reduced at all.

As described above, the respective surrounding portions 3d2 of the valve seat 3d surround the first ports 3b one by one, and are provided at one end of the valve disc 3 so as to protrude toward the compression side chamber R2 side in the axial direction from the axial position of the inlet ends of the second ports 3c. Therefore, even when a check valve made of an annular plate having a circular annular shape is seated on the valve seat 3d, a gap that allows the second ports 3c to communicate with the compression side chamber R2 is formed between the check valve and the main body portion 3a. Therefore, even when the circular annular check valve is seated on the valve seat 3d, the inlet ends of the second ports 3c are not closed.

As described above, the valve disc 3 of the present embodiment can be used not only for the check valve 4 including the inner ring 4a and the plurality of valve portions 4b but also for a circular annular check valve. That is, the valve disc 3 of the present embodiment is not a dedicated product that can be used only for the check valve 4 including the inner ring 4a and the plurality of valve portions 4b, but is a general-purpose product that can be used for other check valves.

As illustrated in FIG. 2, a tubular guide member 30 inserted into the inner periphery of the check valve 4 and the spring member 9 is interposed between one end of the valve disc 3 and the valve stopper 23 to be described later. At this time, since the guide member 30 is fitted to an annular recess portion 3i formed on the inner peripheral side of the main body portion 3a of the valve disc 3, the inner ring 4a of the check valve 4 is prevented from being caught by the guide member 30.

Since the inner periphery of the check valve 4 is slidably in contact with the outer periphery of the guide member 30, the axial movement when the check valve 4 is opened and closed is guided by the guide member 30. Therefore, the check valve 4 can smoothly open and close the first ports 3b.

In the present embodiment, the annular spring member 9 is configured by a wave washer, but the spring member 9 may be a disc spring or a rubber ring in addition to the wave washer. The check valve 4 may be biased toward the valve disc 3 side by a coil spring instead of the annular spring member 9, but since the annular spring member 9 has a shorter axial length than the coil spring, the overall length of the damping valve V can be shortened by adopting the annular spring member 9.

In the present embodiment, the check valve 4 is movable in the axial direction on the outer periphery of the guide member 30 and is stacked on the valve seat 3d on one end side of the valve disc 3 so as to be movable toward and away from the valve seat 3d in the axial direction.

However, the guide member 30 may be eliminated, and the inner ring 4a may be fixed to the outer periphery of the guide rod 20 and stacked on the valve seat 3d. In this case, the inner ring 4a of the check valve 4 is fixed, but deflection of the valve portions 4b facing the surrounding portions 3d2 is allowed. Therefore, when the pressure of the reservoir R becomes larger than the pressure of the compression side chamber R2, the check valve 4 can deflect the valve portions 4b to open the first ports 3b.

However, when the check valve 4 is stacked on the valve seat 3d on one end side of the valve disc 3 so as to be movable toward and away from the valve seat 3d in the axial direction as in the present embodiment, the check valve 4 entirely separates from the valve disc 3 to open the first ports 3b. Therefore, even when the plate thickness of the check valve 4 is increased to increase the flexural rigidity of the valve portions 4b, it is possible to ensure a large flow path area between the surrounding portions 3d2 and the valve portions 4b when the valve is opened. Therefore, even when the plate thickness of the check valve 4 is increased, the resistance given to the flow of the hydraulic oil passing through the first ports 3b can be extremely reduced, and the rigidity of the check valve 4 can be increased to prevent deformation of the check valve 4.

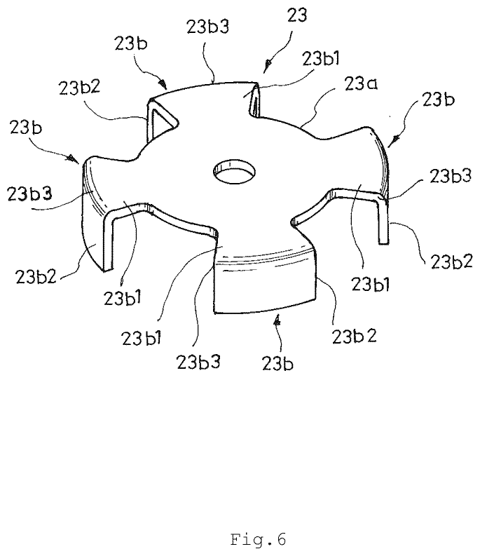

Subsequently, as illustrated in FIGS. 2, 5, and 6, the valve stopper 23 includes an annular plate 23a that is placed on a counter-valve disc side end of the guide member 30 disposed on the inner periphery of the check valve 4 and faces the inner ring 4a of the check valve 4 in the axial direction, and four claws 23b that are provided on the outer periphery of the plate 23a at intervals in the circumferential direction and inserted into the four second ports 3c.

The outer diameter of the plate 23a is set to be smaller than the outer diameter of the spring member 9.

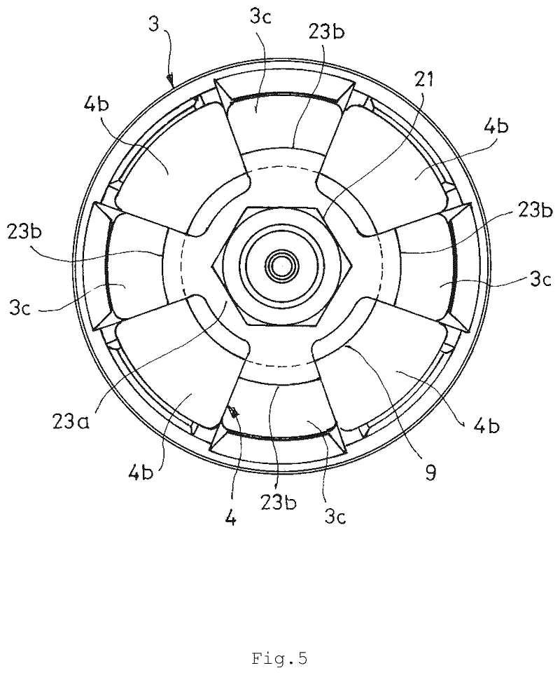

Therefore, in a state where the centers of the plate 23a and the spring member 9 coincide with each other in the axial direction, as illustrated in FIG. 5, the outer periphery of the spring member 9 protrudes to the outside of the plate 23a. As described above, the plate 23a also functions as a spring seat of the spring member 9. In the present embodiment, the outer periphery of the plate 238 is formed in a circular shape, but the outer peripheral shape of the plate 23a is not particularly limited, and may be, for example, a polygonal shape.

The four claws 23b are provided radially outward in the radial direction from the outer periphery of the plate 238, and when the valve stopper 23 is disposed concentrically with the valve disc 3, the claws are inserted into the corresponding second ports 3c while directly facing the second ports 3c.

Specifically, each of the claws 23b includes a horizontal piece 23b1 as a first piece extending in the radial direction from the outer periphery of the plate 23a, a vertical piece 23b2 as a second piece extending in the axial direction from the distal end side of the horizontal piece 23b1 toward the valve disc 3 side and inserted into the second port 3c, and a connection piece 23b3 that is curved and connects the horizontal piece 23b1 and the vertical piece 23b2.

As illustrated in FIG. 5, the vertical piece 23b2 is formed in a circular arc shape having the same radius of curvature as the second port 3c as viewed in the axial direction. A circumferential width of the vertical piece 23b2 is set to a length that exactly fits the second port 3c. Therefore, when the claws 23b are inserted into the second ports 3c, the circumferential side surfaces of the vertical piece 23b2 abut on the circumferential side surfaces of the second port 3c, and the circumferential rotation of the valve stopper 23 with respect to the valve disc 3 is regulated.

Further, a circumferential width between the valve portions 4b and 4b adjacent to each other in the circumferential direction in the check valve 4 is set to a length by which the vertical piece 23b2 is slidably fitted between the valve portions 4b and 4b. Therefore, when the claws 23b of the valve stopper 23 are inserted into the second ports 3c in a state where the check valve 4 is stacked on one end of the valve disc 3 while the valve portions 4b face the first ports 3b, the circumferential side surfaces of the valve portions 4b abut on the circumferential side surfaces of the claws 23b, so that the circumferential rotation of the check valve 4 is regulated. Therefore, the check valve 4 is positioned at a position where the valve portions 4b close the first ports 3b by the valve stopper 23.

In the present embodiment, since the circumferential width between the valve portions 4b and 4b adjacent to each other in the circumferential direction in the check valve 4 coincides with the circumferential width of the vertical piece 23b2, the movement of the valve portion 4b when the check valve 4 is opened and closed is guided by the vertical piece 23b2, so that the check valve 4 can be prevented from shifting in the circumferential direction and rattling.

However, as long as the first ports 3b can be closed when the valve portions 4b of the check valve 4 are seated on the surrounding portions 3d2, there may be a gap between the vertical piece 23b2 and the circumferential side surfaces of the second port 3c, allowing the valve stopper 23 to move slightly in the circumferential direction with respect to the valve disc 3.

Similarly, as long as the first ports 3b can be closed when the valve portions 4b of the check valve 4 are seated on the surrounding portions 3d2, there may be a gap between the vertical piece 23b2 and the circumferential side surfaces of the valve portion 4b, allowing the check valve 4 to move slightly in the circumferential direction with respect to the valve disc 3.

In the present embodiment, a diameter of a circle passing through the inner peripheries of the vertical pieces 23b2 of the four claws 23b is set to be substantially equal to the outer diameter of the spring member 9. Therefore, in a state where the spring member 9 is disposed between the check valve 4 and the valve stopper 23, the outer periphery of the spring member 9 abuts on the inner peripheries of the vertical pieces 23b2 of the claws 23b, so that radial movement of the spring member 9 is regulated.

The length and the plate thickness of the vertical piece 23b2 in the claw 23b are not particularly limited, and may be appropriately determined within a range not affecting the flow of the hydraulic oil passing through the second ports 3c. In addition, the shape of the claw 23b described above is an example, and the shape of the claw 23b is not particularly limited as long as it can be inserted into the second port 3c and can inhibit the circumferential rotation of the check valve 4 in a state of being inserted into the second port 3c. For example, the vertical piece 23b2 of the claw 23b may be formed in a bifurcated shape, and in this case, the valve stopper 23 can be reduced in weight.

In the present embodiment, the valve stopper 23 has the four claws 23b, but the number of claws 23b is not particularly limited as long as the number is one or more and equal to or less than the number of second ports 3c as long as the valve portions 4b of the check valve 4 can be positioned in the circumferential direction. In the present embodiment, the first port 3b, the second port 3c, and the valve portion 4b are each formed in a fan shape, but the shapes of the first port 3b, the second port 3c, and the valve portion 4b are not particularly limited, and may be arbitrarily determined.

In the present embodiment, the valve stopper 23 having the claws 23b is manufactured by bending arms of a base material made of metal and having a shape including the circular annular plate 23a and four plate-shaped arms provided on the outer periphery of the plate 23a at intervals in the circumferential direction and extending radially from the outer periphery of the plate 23a. However, the method of manufacturing the valve stopper 23 is not limited to the above-described method, and the valve stopper 23 may be manufactured by, for example, welding the claws 23b to the outer periphery of the plate 23a, forging, or casting. In addition, the valve stopper 23 may be manufactured, for example, by molding a synthetic resin with a mold, or may be formed of a material other than metal.

Returning to the above, as illustrated in FIG. 2, the leaf valve 5 is a stacked leaf valve formed by stacking a plurality of circular annular plates, and is stacked on the petal-type valve seat 3h provided on the end surface facing the reservoir R side, which is the other end of the valve disc 3. The inner periphery of the leaf valve 5 is fixed in a state of being fitted to the outer periphery of the guide rod 20 and seated on the petal-type valve seat 3h, and is allowed to deflect on the outer peripheral side. The leaf valve 5 closes the second ports 3c when seated on the petal-type valve seat 3h, and deflects on the outer peripheral side when the pressure of the compression side chamber R2 acting on the front side, which is the side of the second ports 3c, becomes larger than the pressure of the reservoir R acting on the back side. When the outer periphery of the leaf valve 5 is deflected in this manner, the outer periphery is separated from the petal-type valve seat 3h and the second ports 3c are opened, and the leaf valve 5 allows the flow of the hydraulic oil from the compression side chamber R2 toward the reservoir R and gives resistance to the flow of the hydraulic oil. When the pressure of the reservoir R is larger than the pressure of the compression side chamber R2, the leaf valve 5 is pressed against the petal-type valve seat 3h to close the second ports 3c, thereby inhibiting the flow of the hydraulic oil from the reservoir R toward the compression side chamber R2.

The petal-type valve seat 3h surrounds only the second ports 3c, and is provided at the other end of the valve disc 3 so as to protrude toward the reservoir R side in the axial direction from the axial position of the inlet ends of the first ports 3b. Therefore, even in a state where the leaf valve 5 is seated on the petal-type valve seat 3h, a gap facing the inlet ends of the first ports 3b is formed between the leaf valve 5 and the petal-type valve seat 3h of the valve disc 3, so that the leaf valve 5 does not close the inlet ends of the first ports 3b.

The damping valve V configured as described above is assembled to the outer periphery of an attachment shaft 20a1 of a disc holding portion 20a provided at the distal end of the guide rod 20, and is fixed to the guide rod 20 by a nut 21 screwed to the lower end in FIG. 2, which is the distal end of the attachment shaft 20a1. As illustrated in FIG. 2, the guide rod 20 includes a rod main body 20b connected to the cap 11 and the disc holding portion 20a attached to the distal end of the rod main body 20b. The disc holding portion 20a includes the small-diameter attachment shaft 20a1 at the distal end thereof, and a proximal end thereof is screwed to the distal end of the rod main body 20b.

The number of first ports 3b and second ports 3c installed in the present embodiment is not limited to four as long as it is plural. Since the surrounding portions 3d2 in the valve seat 3d are provided on a one-to-one basis for the respective first ports 3b, the number of first ports 3b and the number of surrounding portions 3d2 are the same, and the number of valve portions 4b of the check valve 4 may be the same as the number of first ports 3b and surrounding portions 3d2.

Next, a method of assembling the damping valve V to the outer periphery of the attachment shaft 20a1 of the disc holding portion 20a provided at the distal end of the guide rod 20 will be described in detail. First, the leaf valve 5 and the valve disc 3 are assembled to the attachment shaft 20a1 of the guide rod 20 in this order. Next, after the guide member 30 is fitted to the annular recess portion 3i of the valve disc 3, the check valve 4 is stacked on the lower end of the valve disc 3 while being disposed on the outer periphery of the guide member 30. Further, the spring member 9 is overlapped on the outer periphery of the guide member 30 on the counter-valve disc side of the check valve 4.

Next, the valve portions 4b of the check valve 4 are made to face the first ports 3b, and in this state, while the claws 23b are inserted into the second ports 3c, the plate 23a is overlapped on the lower end which is the counter-valve disc side end of the guide member 30, and the valve stopper 23 is assembled to the attachment shaft 20a1.

In a state in which the valve stopper 23 is assembled to the attachment shaft 20a1 in this manner, as described above, the claws 23b abut on the circumferential side surfaces of the second ports 3c to regulate the circumferential rotation of the valve stopper 23, and the circumferential side surfaces of the valve portions 4b abut on the claws 23b to regulate the circumferential rotation of the check valve 4. Therefore, the check valve 4 is positioned at a position where the valve portions 4b close the first ports 3b by the valve stopper 23.

Furthermore, in a state where the valve stopper 23 is assembled to the attachment shaft 20a1, as described above, the outer diameter of the plate 23a is smaller than the outer diameter of the spring member 9, so that the outer periphery of the spring member 9 protrudes to the outside of the plate 23a as illustrated in FIG. 5.

Therefore, even when the position of the spring member 9 is shifted when the valve stopper 23 is assembled to the attachment shaft 20a1, the spring member 9 can be operated from the outside to return the position of the spring member 9 to the correct position. In particular, in the present embodiment, since the tubular guide member 30 is disposed on the inner periphery of the spring member 9, when the valve stopper 23 is assembled to the attachment shaft 20a1, the spring member 9 may ride on the lower end of the guide member 30, but even in such a case, the spring member 9 can be operated from the outside to return the spring member 9 to the correct position between the check valve 4 and the valve stopper 23. Therefore, when the valve stopper 23 is assembled to the attachment shaft 20a1, since it is not necessary to carefully perform work so that the spring member 9 does not ride on the guide member 30, the assembly workability is improved.

Furthermore, when the spring member 9 is disposed on the outer periphery of the attachment shaft 20a1 in this manner, the radial movement Of the spring member 9 disposed on the inner peripheral side of the claws 23b of the valve stopper 23 is regulated by the inner peripheries of the plurality of claws 23b, so that the spring member 9 is aligned such that the center of the spring member 9 coincides with the center of the valve disc 3 in the axial direction. As long as the spring member 9 is aligned, there may be a gap between the spring member 9 and the inner peripheral surfaces of the vertical pieces 23b2 of the claws 23b. Finally, the damping valve V is fixed to the guide rod 20 by screwing and tightening the nut 21 to the lower end, which is the distal end of the attachment shaft 20a1 in FIG. 2.

Subsequently, a free piston 24 having a bottomed tubular shape is slidably mounted to the outer periphery of the guide rod 20 and above the valve disc 3 in FIG. 1. The bottom portion of the free piston 24 has an annular shape, and the guide rod 20 is inserted into the inner peripheral side thereof. The free piston 24 is also slidably in contact with the inner periphery of the reservoir cylinder 1a, and partitions the reservoir R in the reservoir cylinder 1a into a liquid chamber I filled with hydraulic oil and a gas chamber G filled with a gas. Furthermore, a pressure spring 25 formed of a coil spring is interposed in a compressed state between the bottom portion of the free piston 24 and the cap 11, and the free piston 24 is constantly biased in a direction of compressing the liquid chamber I side by the pressure of the pressure spring 25 and the pressure in the gas chamber G.

As described above, in the shock absorber D of the present embodiment, the free piston 24 is biased by the pressure spring 25 to cause a compressive force to act on the liquid chamber L, so that the extension side chamber R1 and the compression side chamber R2 in the cylinder 1 communicating with the liquid chamber I are pressurized to increase the oil column rigidity. Since the gas is dissolved in the hydraulic oil, the hydraulic oil exhibits elasticity, and when an apparent elastic coefficient of the hydraulic oil decreases, damping force generation responsiveness of the shock absorber D deteriorates. However, by pressurizing the inside of the cylinder 1 as described above, the oil column rigidity can be increased, and the damping force generation responsiveness of the shock absorber D can be improved.

A hole 1c communicating with the outside of the shock absorber D is provided in a side portion of the reservoir cylinder 1a of the cylinder 1. The hole 1c is maintained in a state of being closed by the free piston 24 when the free piston 24 faces the hole 1c. However, when the amount of hydraulic oil in the liquid chamber L becomes larger than a prescribed amount and the free piston 24 retracts upward from the hole 1c, the hydraulic oil in the liquid chamber L is discharged to the liquid storage chamber R3 outside the shock absorber D via the hole 1c, and it is possible to prevent the inside of the cylinder 1 from being excessively high pressure.

The shock absorber D is configured as described above, and its operation will be described below. First, when the front fork F extends, the piston 6 connected to the rod 2 moves downward in FIG. 1 with respect to the cylinder 1 along with the relative axial separation between the vehicle body side tube 10 and the axle side tube 12.

The extension side chamber R1 in the cylinder 1 is compressed and reduced by the movement of the piston 6, and the compression side chamber R2 in the cylinder 1 is expanded by the movement of the piston 6. The hydraulic oil in the extension side chamber R1 to be compressed pushes and opens the extension side leaf valve 17, passes through the extension side port 6a of the piston 6, and moves to the compression side chamber R2 to be expanded.

Since the extension side leaf valve 17 gives resistance to the flow of the hydraulic oil passing through the extension side port 6a, the pressure of the extension side chamber R1 becomes higher than the pressure of the compression side chamber R2, and the shock absorber D exerts an extension side damping force that hinders its own extension.

When the shock absorber D extends, the rod 2 is retracted from the cylinder 1, and the hydraulic oil corresponding to the volume of the rod 2 retracted from the cylinder 1 is insufficient in the compression side chamber R2 in the cylinder 1. Since the hydraulic oil is insufficient in the compression side chamber R2 in this manner, the pressure of the compression side chamber R2 is lower than the pressure of the reservoir R, and the valve portions 4b of the check valve 4 are opened to open the first ports 3b. Therefore, the hydraulic oil insufficient in the compression side chamber R2 is supplied from the liquid chamber I of the reservoir R to the compression side chamber R2 through the first ports 3b. In the reservoir R, since the hydraulic oil moves from the liquid chamber L to the compression side chamber R2, the free piston 24 moves downward to reduce the liquid chamber I and expand the gas chamber G, thereby compensating for the volume of the rod 2 retracting from the cylinder 1. As described above, when the front fork F extends, the shock absorber D extends together to generate an extension side damping force that hinders the extension of the front fork F by the extension side leaf valve 17.

Subsequently, when the front fork F contracts, the piston 6 connected to the rod 2 moves upward in FIG. 1 with respect to the cylinder 1 as the vehicle body side tube 10 and the axle side tube 12 approach each other relatively in the axial direction. The compression side chamber R2 in the cylinder 1 is compressed and reduced by the movement of the piston 6, and the extension side chamber R1 in the cylinder 1 is expanded by the movement of the piston 6. The hydraulic oil in the compression side chamber R2 to be compressed pushes and opens the check valve 18, passes through the compression side port 6b of the piston 6, and moves to the extension side chamber R1 to be expanded. Since the check valve 18 hardly gives resistance to the flow of the hydraulic oil passing through the compression side port 6b, the pressure of the compression side chamber R2 and the pressure of the extension side chamber R1 are substantially equal.

When the shock absorber D contracts, the rod 2 enters the cylinder 1, and the hydraulic oil corresponding to the volume of the rod 2 entering the cylinder 1 becomes excessive in the cylinder 1. The hydraulic oil thus excessive in the cylinder 1 pushes and opens the leaf valve 5, passes through the second ports 3c of the valve disc 3, and moves to the liquid chamber I of the reservoir R.

Since the leaf valve 5 gives resistance to the flow of the hydraulic oil passing through the second ports 3c, the entire pressure in the cylinder 1 increases, and the shock absorber D exerts a compression side damping force that hinders its own contraction. In the reservoir R, since the hydraulic oil is discharged from the inside of the cylinder body 1b into the liquid chamber I, the free piston 24 retracts upward to expand the liquid chamber L and reduce the gas chamber G, thereby compensating for the volume of the rod 2 entering the cylinder 1. When the front fork F contracts, the cylinder 1 moves downward in FIG. 1 in the axle side tube 12, the oil level of the hydraulic oil in the liquid storage chamber R3 rises with the movement of the cylinder 1, and the hydraulic oil in the liquid storage chamber R3 may pass through the hole 15a of the spring seat 15. The hole 15a functions as an orifice valve for the flow through which the hydraulic oil passes. Therefore, when the front fork F contracts, the shock absorber D contracts together to generate a compression side damping force that hinders the contraction of the front fork F by the leaf valve 5, and when the oil level passes through the hole 15a of the spring seat 15, a damping force that hinders the contraction by the spring seat 15 can be added to the compression side damping force of the shock absorber D.

As described above, when the shock absorber D contracts, the hydraulic oil moves from the inside of the cylinder 1 to the liquid chamber I through the second ports 3c, but the valve portions 4b of the check valve 4 do not reduce the flow path area of the inlets of the second ports 3c. Therefore, even when the piston speed of the shock absorber D increases and the flow rate passing through the second ports 3c increases, the orifice characteristic does not appear in the damping characteristic of the shock absorber D of the present embodiment, and the damping force of the shock absorber D does not become excessive. In addition, since the valve portions 4b are supported by the surrounding portions 3d2 in the valve seat 3d while directly facing the surrounding portions 3d2, the valve portions 4b are suppressed from being deformed and fatigued by being recessed toward the first ports 3b due to the pressure of the compression side chamber R2.

As described above, the shock absorber D according to the present embodiment includes the shock absorber main body A that includes the cylinder 1 and the rod 2 movably inserted into the cylinder 1, the shock absorber main body being extendable and contractible; the valve disc 3 that partitions the compression side chamber (operation chamber) R2 and the reservoir (operation chamber) R in the shock absorber main body A, the valve disc 3 including the plurality of first ports 3b and the plurality of second ports 3c that allow communication between the compression side chamber R2 and the reservoir R; the annular check valve 4 that is stacked on one end side of the valve disc 3 and opens and closes the first ports 3b; the annular leaf valve 5 that is stacked on the other end side of the valve disc 3 and opens and closes the second ports 30; and the valve stopper 23 that is disposed on the counter-valve disc side of the check valve 4. The first ports 3b and the second ports 3c are alternately arranged in the circumferential direction of the valve disc 3. The check valve 4 includes the inner ring 4a facing the inner peripheral side of the first ports 3b and the second ports 3c of the valve disc 3, and the plurality of valve portions 4b that are continuous with the outer periphery of the inner ring 4a and independently open and close only the first ports 3b. The valve stopper 23 includes the annular plate 23a facing the inner ring 4a of the check valve 4 in the axial direction, and the claws 23b that extend from the outer periphery of the plate 23a and are inserted into the second ports 3c to regulate the circumferential rotation of the check valve 4.

In the shock absorber D configured as described above, since the circumferential rotation of the check valve 4 is regulated by the claws 23b of the valve stopper 23 inserted into the second ports 3c, the check valve 4 can be positioned at a position where the valve portions 4b and the first ports 3b face each other. Further, since it is not necessary to provide a positioning portion in the valve disc 3 as in the conventional shock absorber, the valve disc 3 of the shock absorber D of the present invention can also be used for another shock absorber including a check valve formed of an annular plate having a circular annular shape. Therefore, since the check valve 4 including the inner ring 4a and the plurality of valve portions 4b is not a dedicated product, the manufacturing cost of the shock absorber D can be reduced.

In the shock absorber D of the present embodiment, the check valve 4 is formed of the plate including one inner ring 4a and the plurality of valve portions 4b. However, the check valve 4 may be formed of a plurality of plates. When the check valve 4 is formed of a plurality of plates, the radial lengths of the valve portions 4b may be different between the plates.

Further, in the shock absorber D of the present embodiment, the check valve 4 is stacked so as to be movable toward and away from the valve disc 3 in the axial direction, and includes the annular spring member 9 interposed between the valve stopper 23 and the check valve 4 to bias the check valve 4 toward the valve disc 3, the valve stopper 23 has the four claws 23b, the claws 23b are provided on the outer periphery of the plate 23a at intervals in the circumferential direction and are inserted between the valve portions 4b and 4b, and the spring member 9 abuts on the inner periphery of each claw 23b to regulate the radial movement.

In the shock absorber D configured as described above, since the spring member 9 abuts on the inner peripheries of the four claws 23b to regulate the radial movement, the spring member 9 is concentrically aligned in the radial direction with respect to the valve disc 3. In the shock absorber D configured as described above, since there is no possibility that the annular spring member 9 is shifted in the radial direction, the position of the spring member 9 to bias the check valve 4 does not change during the extension/contraction operation of the shock absorber D. Therefore, since the force by which the spring member 9 biases the check valve 4 is not biased in the radial direction, it is possible to prevent the opening/closing timing of each valve portion 4b in the check valve 4 from being shifted.

Furthermore, in the shock absorber D configured as described above, since the claws 23b that regulate the circumferential rotation of the check valve 4 are also used to regulate the radial movement of the annular spring member 9, it is not necessary to newly provide a structure that regulates the radial movement of the spring member 9, and the cost can be reduced.

In the present embodiment, the valve stopper 23 has the four claws 23b arranged at equal intervals in the circumferential direction, and the radial movement of the spring member 9 is regulated by setting the diameter of the circle passing through the inner peripheries of the four claws 23b to be substantially equal to the outer diameter of the spring member 9. However, when the number of claws 23b is three or more, the radial movement of the spring member 9 can be regulated by setting the diameter of the circle passing through the inner peripheries of these claws 23b to be substantially equal to the outer diameter of the spring member 9.

For example, when the radial movement of the spring member 9 is regulated by the means other than abutting the spring member 9 on the inner peripheries of the claws 23b, such as when the inner diameter of the spring member 9 is equal to the outer diameter of the guide member 30 and the radial movement of the spring member 9 is regulated by bringing the spring member 9 into sliding contact with the outer periphery of the guide member 30, a diameter of a circle passing through the inner periphery of each claw 23b may be set to be equal to or larger than the outer diameter of the spring member 9, or the number of claws 23b may be one.

Although a coil spring may be adopted instead of the annular spring member 9, the annular spring member 9 such as a wave washer, a disc spring, or a rubber ring has a shorter axial length than the coil spring as in the present embodiment, so that the overall length of the damping valve V can be shortened by adopting the annular spring member 9.

In the shock absorber D of the present embodiment, the outer diameter of the spring member 9 is larger than the outer diameter of the plate 23a.

In the shock absorber D configured as described above, since the outer periphery of the spring member 9 protrudes to the outside of the plate 23a, even when the position of the spring member 9 is shifted when the valve stopper 23 is assembled, the spring member 9 can be operated from the outside to return the position of the spring member 9 to the correct position. Therefore, when the valve stopper 23 is assembled, it is not necessary to carefully perform work so that the position of the spring member 9 is not shifted, so that assembly workability is improved.

In particular, in the shock absorber D of the present embodiment, since the tubular guide member 30 is disposed on the inner periphery of the check valve 4, when the valve stopper 23 is assembled to the attachment shaft 20a1, the spring member 9 may ride on the counter-valve disc side end of the guide member 30. Even in such a case, the spring member 9 can be operated from the outside to return the spring member 9 to the correct position between the check valve 4 and the valve stopper 23. Therefore, when the valve stopper 23 is assembled, since it is not necessary to carefully perform work so that the spring member 9 does not ride on the guide member 30, the assembly workability is improved.

However, the outer diameter of the spring member 9 may be equal to or smaller than the outer diameter of the plate 23a. The guide member 30 may be omitted, and the check valve 4 and the spring member 9 may be directly attached to the outer periphery of the attachment shaft 20a1.

As described above, in the present embodiment, the outer diameter of the spring member 9 is larger than the outer diameter of the plate 23a of the valve stopper 23. Therefore, when the extension speed of the shock absorber D is high, the flow rate of the hydraulic oil passing through the first ports 3b increases, so that the check valve 4 may deflect with the outer peripheral end of the spring member 9 as a fulcrum in a state of being separated from the valve seat 3d to the maximum. Then, the spring member 9 is deflected together with the valve portions 4b, and a large load is applied to the spring member 9.

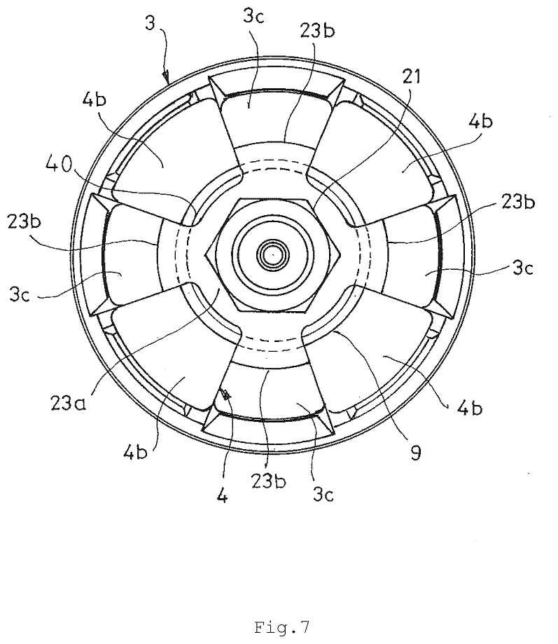

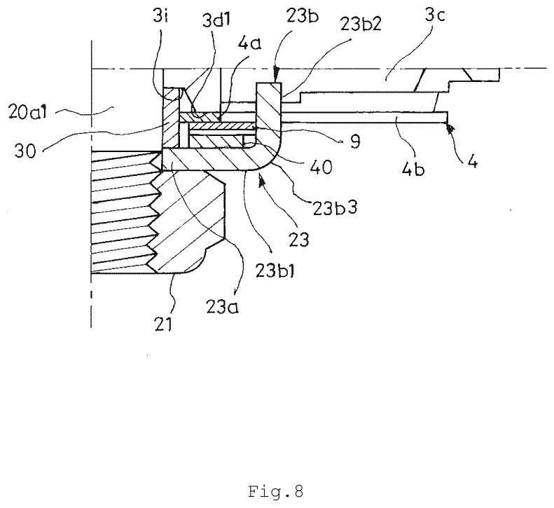

Therefore, as in a modification of the present embodiment illustrated in FIGS. 7 and 8, a washer 40 may be overlapped on the spring member 9 in the axial direction. According to this configuration, even when the check valve 4 deflects with the outer peripheral end of the spring member 9 as a fulcrum, the spring member 9 is supported by the washer 40 to suppress deflection of the spring member 9, and deterioration of the spring member 9 due to fatigue can be suppressed.

In addition, in order to suppress deterioration of the spring member 9 due to fatigue, it is conceivable to increase the rigidity of the spring member 9 by increasing the plate thickness of the spring member 9. However, in a case where the plate thickness of the spring member 9 is increased, the biasing force of the spring member 9 increases, and there is a possibility that resistance is given to the flow of the hydraulic oil when the check valve 4 is opened. On the other hand, when the washer 40 is overlapped on the spring member 9 as in the modification of the present embodiment, the biasing force of the spring member 9 does not change, so that it is possible to prevent the generation of the damping force due to the resistance given to the flow of the hydraulic oil when the check valve 4 is opened.

As described above, the claws 23b each include the horizontal piece 23b1 as the first piece extending in the radial direction from the outer periphery of the plate 23a, the vertical piece 23b2 as the second piece extending in the axial direction from the distal end side of the horizontal piece 23b1 toward the valve disc 3 side and inserted into the second port 3c, and the connection piece 23b3 connecting the horizontal piece 23b1 and the vertical piece 23b2 while curving.

In the claw 23b configured as described above, the diameter of the circle passing through the inner periphery of each connection piece 23b3 is smaller than the diameter of the circle passing through the inner periphery of each vertical piece 23b2. Therefore, when the spring member 9 that had been abutting on the inner periphery of the vertical piece 23b2 is pushed toward the counter-valve disc side by the check valve 4 and abuts on the inner periphery of the connection piece 23b3 when the check valve 4 is opened, the spring member 9 may be deflected and the spring member 9 may not exhibit original performance, or a large stress may be applied to the spring member 9.

In addition, since the diameter of the circle passing through the inner periphery of each connection piece 23b3 is smaller than the diameter of the circle passing through the inner periphery of each vertical piece 23b2, when the spring member 9 abuts on the inner periphery of the connection piece 23b3, the spring member 9 is shifted in the radial direction. Then, when the check valve 4 is separated from the valve seat 3d to the maximum and deflects with the outer peripheral end of the spring member 9 as a fulcrum, the position of the fulcrum changes.

Therefore, in the shock absorber D according to the modification of the present embodiment, as illustrated in FIGS. 7 and 8, the outer diameter of the horizontal piece 23b1 is made larger than the outer diameter of the washer 40, and the washer 40 is disposed between the spring member 9 and the valve stopper 23.

In the shock absorber D configured as described above, since the washer 40 is interposed between the spring member 9 and the valve stopper 23, a gap corresponding to the plate thickness of the washer 40 is formed between the spring member 9 and the valve stopper 23, so that the spring member 9 can be prevented from abutting on the inner periphery of the connection piece 23b3. Therefore, it is possible to prevent the spring member 9 from abutting on the inner periphery of the connection piece 23b3 and being deflected or shifted in the radial direction. In addition, it is possible to prevent the spring member 9 from abutting on the connection piece 23b3 and a large stress being applied to the spring member 9. In addition, since the outer diameter of the horizontal piece 23b1 is larger than the outer diameter of the washer 40, the washer 40 does not abut on the inner periphery of the connection piece 23b3 and is not deflected.

In the present embodiment, the connection piece 23b3 connects the distal end of the horizontal piece 23b1 and the proximal end of the vertical piece 23b2 while curving, but the connection piece 23b3 may connect the distal end of the horizontal piece 23b1 and the proximal end of the vertical piece 23b2 while inclining.

In addition, when the washer 40 is provided only for suppressing deterioration of the spring member 9 due to fatigue, the washer 40 may be disposed between the spring member 9 and the valve disc 3.

Although the preferred embodiment of the present invention has been described above in detail, modifications, variations, and changes are possible without departing from the scope of the claims.

### REFERENCE SIGNS LIST

1 Cylinder
2 Rod
3 Valve disc
3b First port
3c Second port
3d Valve seat
4 Check valve
4a Inner ring
4b Valve portion
5 Leaf valve
6 Piston
9 Spring member
23 Valve stopper
23a Plate
23b Claw
23b1 Horizontal piece (first piece)
23b2 Vertical piece (second piece)
23b3 Connection piece
30 Guide member
40 Washer
A Shock absorber main body
D Shock absorber
R Reservoir (operation chamber)
R2 Compression side chamber (operation chamber)

1. A shock absorber comprising:
a shock absorber main body that includes a cylinder and a rod movably inserted into the cylinder, the shock absorber main body being extendable and contractible;
a valve disc that partitions two operation chambers in the shock absorber main body, the valve disc including a plurality of first ports and a plurality of second ports that allow communication between the two operation chambers;
an annular check valve that is stacked on one end side of the valve disc and opens and closes the first ports;
an annular leaf valve that is stacked on the other end side of the valve disc and opens and closes the second ports; and
a valve stopper that is disposed on a counter-valve disc side of the check valve, wherein
the first ports and the second ports are alternately arranged in a circumferential direction of the valve disc,
the check valve includes an inner ring facing an inner peripheral side of the first ports and the second ports of the valve disc, and a plurality of valve portions that are continuous with an outer periphery of the inner ring and independently open and close only the first ports, and
the valve stopper includes an annular plate facing the inner ring of the check valve in an axial direction, and claws that extend from an outer periphery of the plate and are inserted into the second ports to regulate circumferential rotation of the check valve.

2. The shock absorber according to claim 1, wherein
the check valve is stacked so as to be movable toward and away from the valve disc in the axial direction,
the shock absorber further comprises an annular spring member that is interposed between the valve stopper and the check valve and biases the check valve toward the valve disc,
the valve stopper has three or more of claws,
the claws are provided on the outer periphery of the plate at intervals in the circumferential direction and inserted between the valve portions, and
the spring member abuts on an inner periphery of each of the claws to regulate radial movement.

3. The shock absorber according to claim 2, wherein
an outer diameter of the spring member is larger than an outer diameter of the plate.

4. The shock absorber according to claim 3, further comprising
a washer that is overlapped on the spring member in the axial direction and is disposed between the spring member and the valve stopper, wherein
the claws each include a first piece extending in a radial direction from the outer periphery of the plate, a second piece extending in the axial direction from a distal end side of the first piece toward the valve disc side and inserted into the second port, and a connection piece connecting the first piece and the second piece in an inclined manner or a curved manner, and
an outer diameter of the first piece is larger than an outer diameter of the washer.
